(19) United States
(12) Patent Application Publication
(10) Pub. No.: US 2015/0065229 A1
(43) Pub. Date: Mar. 5, 2015

(54) REWARD METHOD ACCORDING TO A GAME PLAY NUMBER IN AN ONLINE GAME AND A SERVER PERFORMING THE SAME

(71) Applicant: Intellectual Discovery Co., Ltd., Seoul (KR)

(72) Inventors: Yoon Namgoong, Seoul (KR); Young Jae Park, Seoul (KR)

(73) Assignee: Intellectual Discovery Co., Ltd., Seoul (KR)

(21) Appl. No.: 14/363,993

(22) PCT Filed: Nov. 28, 2012
(86) PCT No.: PCT/KR2012/010127

§ 371 Date: Oct. 21, 2014

(30) Foreign Application Priority Data
Dec. 8, 2011 (KR) 10-2011-0131340

(51) Int. Cl. A63F 13/792

(52) U.S. Cl. CPC A63F 13/792
USPC 463/25

(57) ABSTRACT

The present invention relates to a technique providing any one of an item or cyber money according to a game play number on an online game of a user. A reward method according to a game play number in the online game through a game operating server includes: searching user information of a user on game access detection of the user to extract a play number as a number of games that the user has finished during a predetermined period; accumulating the play number every time the play is finished when the user plays the game through the game operating server; determining whether the accumulated play number is the same as a predetermined play number; and providing a predetermined reward to the user when the accumulated play number is the same as the predetermined play number.

### TECHNICAL FIELD

The present invention relates to a reward method according to a game play number in an online game providing one of an item or cyber-money according to the game play number in the online game of a user, and a server performing the same.

### BACKGROUND ART

Recently, as a network technique and a contents technique have been developed, a number of users using the online game has suddenly increased. As the utilization of online games increases, various game plays become possible through a competition and cooperation between the users, and accordingly, the online game becomes the contents capable of building social networks over a dimension of the simple game.

Generally, a paid or free online game provided on the Internet is provided with various genres such as a simulation game, a role playing game, a mug game, and a shutting game, and a gamer in a process of playing the game may remove an object or may obtain an item, and a point, a level, and an experience value are stimulated and obtained.

The above information disclosed in this Background section is only for enhancement of understanding of the background of the invention and therefore it may contain information that does not form the prior art that is already known in this country to a person of ordinary skill in the art.

### DISCLOSURE

### Technical Problem

The present invention provides a reward method according to a game play number in an online game capable of guiding game participation of a user by providing one of the item or cyber money according to the game play number in the online game of the user.

### Technical Solution

A reward method according to a game play number in an online game through a game operating server according to an exemplary embodiment of the present invention includes: searching user information of a user on game access detection of the user to extract a play number as a number of games that the user has finished during a predetermined period; accumulating the play number every time the play is finished when the user plays the game through the game operating server; determining whether the accumulated play number is the same as a predetermined play number; and providing a predetermined reward to the user when the accumulated play number is the same as the predetermined play number.

In the present invention, the predetermined play number is an integer multiple of a predetermined unit play number.

In the present invention, in the providing, at least one of the item and the cyber money is provided as the reward according to one of a win number of the user in the game play or a successive win number.

In the present invention, the determining may further include determining whether the accumulated play number exceeds a predetermined threshold play number.

In the present invention, the providing further includes stopping the providing of at least one of the item and the cyber money when the accumulated play number exceeds the predetermined threshold play number.

In the present invention, after the determining, outputting a remaining play number to be played by the user until the predetermined play number when the accumulated play number is smaller the predetermined play number is further included.

In the accumulating of the play number, the user only accumulates the winning play number after the play is finished, and in the providing of the reward, the predetermined reward is provided to the user when the accumulated winning play number of the user is the same as the predetermined win number.

In the accumulating of the play number, a successive win number as a play number of successive winning is determined is accumulated when it is determined that the user successively wins after the play is finished, and in the providing of the reward, the predetermined reward is provided to the user when the accumulated successive win number is the same as the predetermined successive win number.

A server delivering a reward according to a game play number in an online game according to an exemplary embodiment of the present invention includes: an accumulation module accumulating a play number as a number of games that a user has finished during a predetermined period when the user accesses a game server to play the game; a reward information generating module generating reward information including an item and cyber money to be used in the game to be provided to the user according to the accumulated play number of the user; and a management module providing a predetermined reward to the user from the reward information generating module when the play number accumulated by the accumulation module is the same as the predetermined play number.

In the present invention, the management module sets the predetermined play number as an integer multiple of a predetermined unit play number.

In the present invention, the management module provides at least one of the item and the cyber money according to one of a win number and a successive win number by the user in the game play.

In the present invention, the management module determines whether the accumulated play number exceeds a predetermined threshold play number to stop the providing of at least one among the item and the cyber money when the accumulated play number exceeds the predetermined threshold play number.

In the present invention, the management module outputs a remaining play number to be played by the user until the predetermined play number when the accumulated play number information is smaller than the predetermined play number.

A computer readable recording medium for recording a program for realizing a reward method according to a play number in an online game through a game operating server according to an exemplary embodiment of the present invention includes: searching user information of a user on game access detection of the user to extract a play number as a number of games that the user has finished during a predetermined period; accumulating the play number every time the play is finished when the user plays the game through the game operating server; determining whether the accumulated play number is the same as a predetermined play number; and providing a predetermined reward to the user when the accumulated play number is the same as the predetermined play number.

### Advantageous Effects

As described above, according to the present invention, either one of the item or the cyber money is provided according to the game play number in the online game of the user such that game participation of the user may be induced.

### DESCRIPTION OF THE DRAWINGS

FIG. 1 is a flowchart of a reward method according to a game play number in an online game according to an exemplary embodiment of the present invention.

FIG. 2 is a flowchart of a reward method according to a game play number in an online game according to another exemplary embodiment of the present invention.

FIG. 3 is a flowchart of a reward method according to a game play number in another online game according to an exemplary embodiment of the present invention.

FIG. 4 is a diagram of a server providing a reward according to a game play number in an online game according to an exemplary embodiment of the present invention.

FIG. 5 to FIG. 7 are examples displayed at a screen of a user terminal according to realization of each exemplary embodiment of the present invention.

### MODE FOR INVENTION

Hereinafter, a computer readable record medium storing a program to realize a reward method according to a game play number in an online game, a server performing the same, and a method thereof according to an exemplary embodiment of the present invention will be described with reference to accompanying drawings.

In the following description, in order to clearly understand the present invention, description of a known technology regarding a characteristic of the present invention will be omitted. It is obvious that the following exemplary embodiment is a detailed description which is provided for more understanding of the present invention, but does not limit the scope of the present invention. Therefore, an equivalent invention which performs the same function as the present invention may also be covered by the scope of the present invention.

In the following description, like reference numerals designate like elements having the same configuration, and redundant description and description of a known technology will be omitted.

In an exemplary embodiment of the present invention, “communication”, “communication network”, and “network” may be used to have the same meaning. The three terminologies indicate a wired or wireless local area and wide area data transmitting/receiving network through which a file is transmitted/received between a user terminal, another user terminal, and a download server.

In the following description, “game server” indicates a server computer that users access to use game contents. In the case of a game which has a small capacity or a small number of users, a plurality of game programs may be operated by one game server. Further, in the case of a game which has a large capacity or a large number of real time accessing members, one or more game servers which operate one game may be provided depending on a function of the game.

In addition, middleware for databases or servers which perform payment processing may be connected to the game server, but the description thereof will be omitted in the present invention.

Herein, an online game indicates game contents that can be used by users who access the aforementioned game server. Particularly, the online game indicates a game that can be simultaneously accessed and enjoyed by a plurality of users and increase levels of the users by, e.g., acquiring experience levels while rearing characters through playing of the game on the game. The online game also indicates a game that can buy various kinds of items on the game to play the game more smoothly.

Also, various community systems may be used in the online game in the present invention. For example, a guild or a clan of the online game may be formed. These concepts mean that the users using the online game are gathered and form one group to organize the groups. Each group may increase fame of the guild or the clan according to a number of users or a level of characters of the users, and thereby the users may use various benefits in the game. For example, if the fame of the guild or the clan is increased, a display on a game screen of the character may be changed (e.g., an effect that a color of a name of the displayed character is changed), or the benefit of using the item and a village may be enjoyed in the game.

Also, the community system available in the online game has a party play. The party play as the group on the game play realized through a requirement, an invitation, and an acceptance between the users may use an independent chatting system between the organized party members and may use a certain display capable of identifying the party members on the game screen.

Also, between the users anticipating the party play, the item is distributed, or a result contents obtaining a result of the game play may be shared. A sharing method may also be set by respectively owning the result contents and distributing at least a portion of the result contents to other characters.

In the present invention, the result contents means all contents capable of being obtained by the character of the play result users in the play of the game. For example, in a case of a shooting game, the experience value and the cyber money that are obtained when finishing one game may be included in the result contents, and in a case of a sports game, the experience value and the cyber money that are obtained when finishing one game may be the result contents. In the case of the role playing game, the experience value and the reward cyber money obtained when completing a certain quest or killing monsters may be the result contents.

When the character of the user in the online game obtains the certain result contents, all result contents are basically included to the character of the user. Also, when they are included to the party play or the guild or clan, at least a portion of the result contents acquired by the user may be distributed to the character of the other users included the party, the guild, or the clan.

Herein, an item indicates all data that can give assistance to playing the game and can be generally understood as an item on the game. For example, in a role playing game, an item for further increasing an experience level obtained when a character of a user subdues a monster, an item for changing the appearance of the character, and the like may correspond to the items in the present invention.

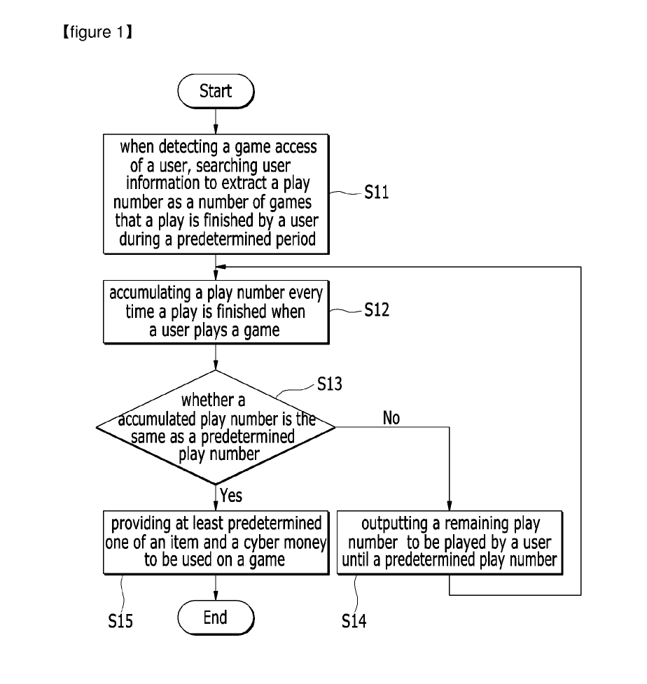

FIG. 1 is a flowchart of a reward method according to a game play number in an online game according to an exemplary embodiment of the present invention.

Referring to FIG. 1, if the user accesses the game screen, a game operating server searches user information of the user stored therein to extract a play number as a number of games of which the play is finished by the user during a predetermined period (S11). Here, the predetermined period set by the game operating server may be a time unit such as a day unit.

Next, the game operating server accumulates a play number every time the game is finished when the user plays the game through the game operating server (S12).

The game operating server determines whether the accumulated play number of the user is the same as a predetermined play number (S13). Here, the predetermined play number as an integer multiple of the unit play number may be 10 games and 20 games.

As a determining result of the game operating server, when the accumulated and calculated play number of the user is not the same as the predetermined play number, a remaining play number to be played by the user until the predetermined play number is output (S14).

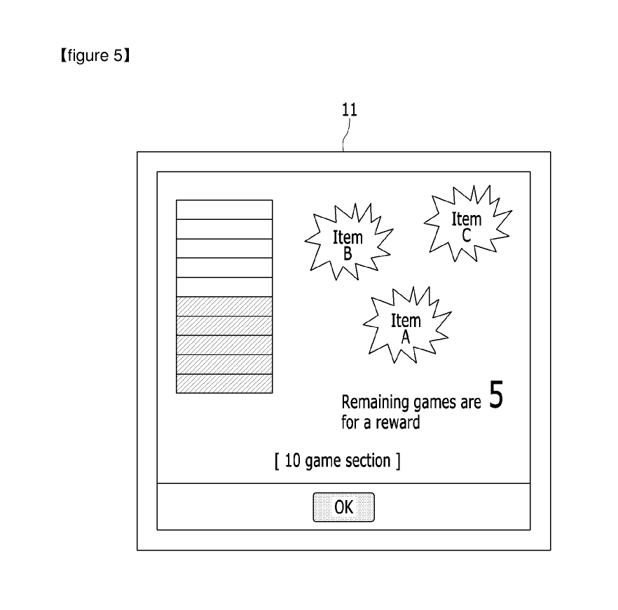

FIG. 5 shows the number of games to be played until either one of the item or the cyber money is rewarded to the user when the predetermined play number is 10 games. Through FIG. 5, the user may confirm that 5 games are currently performed among the 10 games, and that 5 games must be performed henceforth to reward one of an item A, an item B, or an item C. In FIG. 5, only the item is described, however the item may be substituted with cyber money, and a quantity of the cyber money to be rewarded may also be displayed.

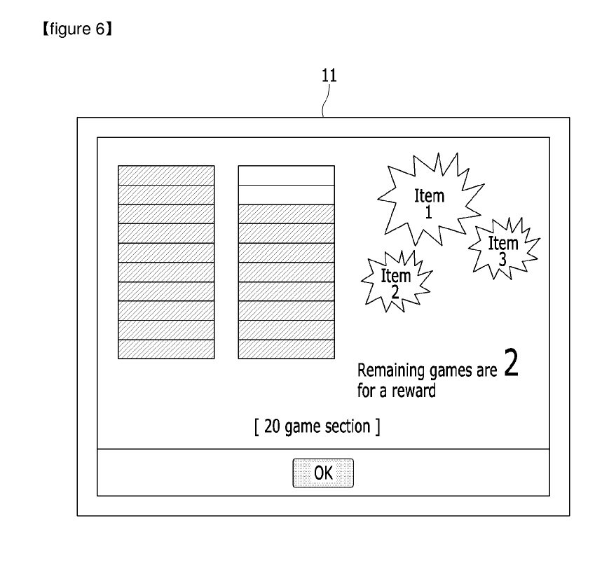

FIG. 6 shows that the number of games to be played until either one of the item or the cyber money is rewarded to the user when the predetermined play number is 20 games. Through FIG. 6, the user may confirm that 18 games have been performed among the 20 games, and that 2 games must be performed henceforth to reward one of the item A, the item B, and the item C. In FIG. 6, the item is only described, however the item may be substituted with the cyber money, and a quantity of the cyber money to be rewarded may also be displayed.

Again referring to FIG. 1, when the accumulated play number of the user is the same as the predetermined play number, the game operating server provides at least a predetermined one of the item and the cyber money to be used in the game (S15).

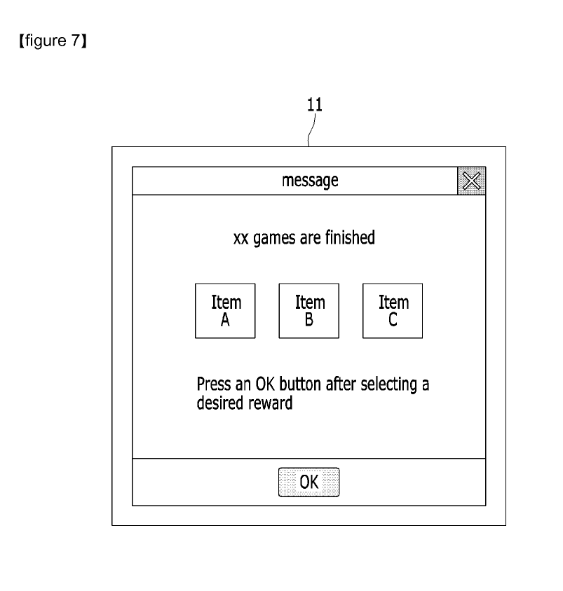

FIG. 7 shows a message window provided to the user from the game operating server when the accumulated play number of the user is the same as the predetermined play number. Referring to FIG. 7, when the user finishes all the predetermined games, a phrase informing this and a kind of the item to be selected are simultaneously shown. If the user selects any one among the items and inputs an OK button, the selected item may be rewarded. In FIG. 7, only the item is described, however the item may be substituted with the cyber money, and a quantity of the cyber money to be rewarded may also be displayed.

Here, the game operating server may provide the item of a further higher level to the user according to one of a win number and a successive win number in the game play. Also, when the accumulated play number of the user exceeds a predetermined threshold play number, the providing of at least one of the item and the cyber money is stopped. For example, if the game operating server sets the threshold play number as 20 games and the user finishes the play of 21 games within the predetermined period, the game operating server does not further provide the item or the cyber money to the user.

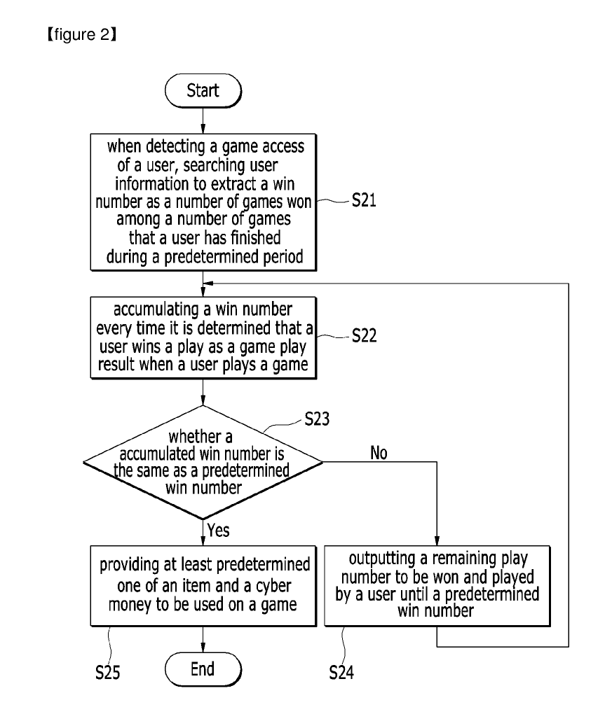

FIG. 2 is a flowchart of a reward method according to a game play number in an online game according to another exemplary embodiment of the present invention.

Referring to FIG. 2, if the user accesses the game screen, a game operating server searches user information of the user stored therein to extract a win number that is a number of games won among a game number that the user has finished during a predetermined period (S21). Here, the predetermined period set by the game operating server may be a time unit such as a day unit.

Next, the game operating server accumulates the win number every time it is determined that the user playing the game wins when the user plays the game through the game operating server (S22).

The game operating server determines whether the accumulated win number of the user is the same as the predetermined win number (S23). Here, the predetermined win number as the integer multiple of the unit win number may be 10 games and 20 games.

When the accumulated win number of the user is not the same as the predetermined win number, that is, the accumulated win number of the user is smaller than the predetermined win number, the game operating server outputs information on the number of games that the user must win until the predetermined win number (S24).

Referring to FIG. 5, the 5 games is the game number to be won remaining until the reward of the user when the predetermined win number is 10 games, and one among the item A, the item B, and the item C may be rewarded when further winning the 5 games.

However, when the accumulated win number of the user is the same as the predetermined win number, the game operating server provides at least a predetermined one of the item and the cyber money to be used in the game (S25).

Referring to FIG. 7, when the user wins all the predetermined games, a phrase informing of this and a kind of the item to be selected are simultaneously shown. If the user selects any one among the items and inputs an OK button, the selected item may be rewarded.

Here, the game operating server determines whether the accumulated and calculated win number of the user exceeds the predetermined threshold win number, and when the accumulated win number exceeds the predetermined threshold win number, the pay of at least one of the item and the cyber money is stopped.

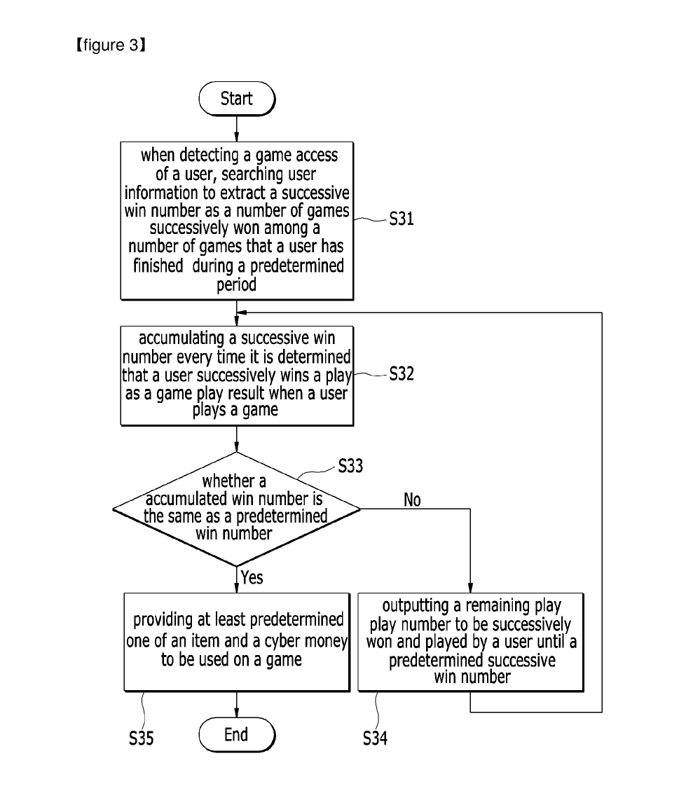

FIG. 3 is a flowchart of a reward method according to a game play number in an online game according to another exemplary embodiment of the present invention.

Referring to FIG. 3, if the user accesses the game screen, a game operating server searches user information of the user stored therein to extract a successive win number that is a number of games that the user has successively won among a game number that the user has finished during a predetermined period (S31). Here, the predetermined period set by the game operating server may be a time unit such as a day unit.

Next, the game operating server accumulates the win number every time it is determined that the user playing the game successively wins when the user plays the game through the game operating server (S32).

The game operating server determines whether the accumulated successive win number of the user is the same as the predetermined successive win number (S33). Here, the predetermined successive win number as the integer multiple of the unit successive win number may be 10 games and 20 games.

When the accumulated successive win number of the user is not the same as the predetermined successive win number, that is, the accumulated successive win number of the user is smaller than the predetermined successive win number, the game operating server outputs play number information on the number of games that the user must successively win until the predetermined successive win number (S34).

FIG. 5 shows that the number of games to be successively won remains as the 5 games until the user may be rewarded when the predetermined successive win number is 10 games, and one among the item A, the item B, and the item C may be rewarded when further winning the 5 games.

However, when the accumulated successive win number of the user is the same as the predetermined successive win number, the game operating server provides at least a predetermined one of the item and the cyber money to be used in the game (S25).

Referring to FIG. 7, when the user successively wins all the predetermined games, a phrase informing of this and a kind of the item to be selected are simultaneously shown. If the user selects any one among the items and inputs an OK button, the selected item may be rewarded.

Here, the game operating server determines whether the accumulated and calculated successive win number of the user exceeds the predetermined successive threshold win number, and when the accumulated successive win number exceeds the predetermined successive threshold win number, the rewarding of at least one of the item and the cyber money is stopped.

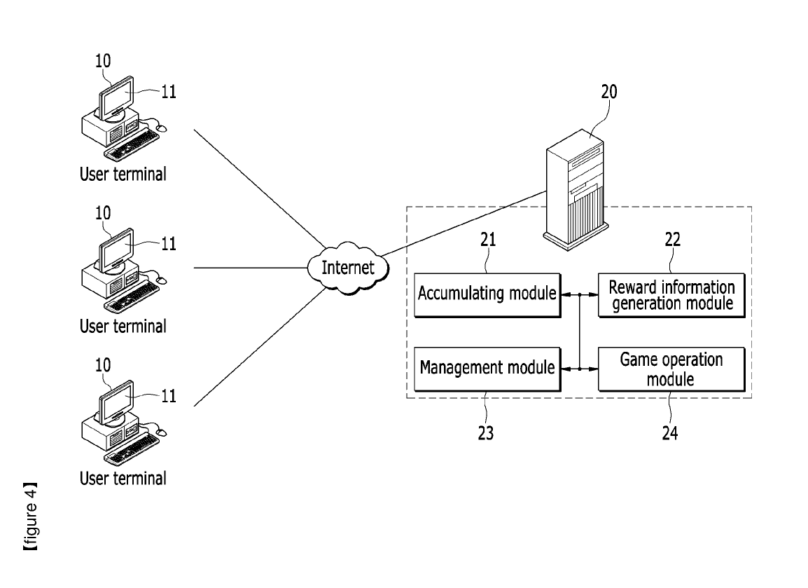

FIG. 4 shows a diagram of a server providing a reward according to a game play number in an online game according to an exemplary embodiment of the present invention, wherein the server includes a user terminal 10 (including a screen 11) and a game operating server 20, and the game operating server 20 includes an accumulation module 21, a reward information generating module 22, a management module 23, and a game operating module 24.

The accumulation module 21 accumulates the play number as a number of games of which the play is finished during the predetermined period when the user accesses the game server to play the game. In the present invention, the accumulation module 21 may accumulate the win number as the number of won games among the game number of which the play is finished by the user during the predetermined period or the successive win number as the number of games that the user has successively among the number of games that the user finishes during the predetermined period.

The reward information generating module 22 generates the reward information including the item and the cyber money to be used in the game to be provided to the user according to the accumulated play number of the user.

The management module 23 provides at least a predetermined one of the item and the cyber money to be used in the game generated in the reward information generating module 22 when the play/win/successive win number accumulated by the accumulation module 21 is the same as the predetermined play/win/successive win number.

The management module 23 sets the predetermined play/win/successive win number as the integer multiple of the unit play/win/successive win number.

The management module 23 determines whether the accumulated play/wing/successive win number of the user exceeds the predetermined threshold play/winning/successive win number, and when the accumulated play/win/successive win number of the user exceeds the predetermined threshold play/win/successive win number, the providing of at least one of the item and the cyber money is stopped.

Also, the management module 23 outputs the remaining play number that the user must play/win/successively win until the predetermined play/win/successive win number when the accumulated play/win/successive win number information of the user is smaller than the predetermined play/win/successive win number.

The game operation module 24 provides various game data to perform the game by the user.

The reward method according to the game play number in the online game in accordance with the exemplary embodiments of the present invention as described above may be executed by the applications basically installed in the terminal (including programs included in a platform, an operating system, or the like which are basically installed in the terminal), and may also be executed by the applications (i.e., programs) which are directly installed in the terminal by the user via an application store server or an application store server such as a web server associated with the applications or the corresponding services. In this respect, the reward method according to the game play number in the online game in accordance with the exemplary embodiments of the present invention may be implemented by the applications (i.e., programs) which are basically installed or directly installed by the user in the terminal, and may be recorded in a computer readable recording medium of the terminal and the like.

The programs are recorded in the computer readable recording medium and are executed by the computer, such that the above-mentioned functions may be executed.

As described above, in order for the computer to read the programs recorded in the recording medium and execute the reward method according to the game play number in the online game in accordance with the exemplary embodiments of the present invention, the above-mentioned programs may include codes which are coded with computer languages such as C, C++, JAVA, machine language, and the like which may be read by a processor (CPU) of the computer.

The code may include a function code associated with a function defining the above-mentioned functions, and may also include an execution procedure related control code required for the processor of the computer to execute the above-mentioned functions according to a predetermined procedure.

In addition, the code may further include a memory reference related code indicating at which location (address number) of the memory inside or outside the computer additional information or media required for the processor of the computer to execute the above-mentioned functions need to be referenced.

Further, in order for the processor of the computer to execute the above-mentioned functions, when the processor needs to communicate with any other computers or servers, etc. at a remote location, the code may further include a communication related code about how the processor of the computer communicates with any other computers or servers at a remote location or which information or media the processor of the computer transmits and receives at the time of the communication, by using the communication module (for example, wired and/or wireless communication module) of the computer.

In addition, a functional program for implementing the present invention, a code and a code segment associated therewith, and the like may be easily inferred or changed by programmers in the art to which the present invention pertains in consideration of a system environment of the computer which reads the recording medium and executes the program.

Hereinabove, examples of a computer readable recording medium recorded with programs as described above include a ROM, a RAM, a CD-ROM, a magnetic tape, a floppy disk, an optical media storage device, and the like.

Further, a computer readable recording medium recorded with programs as described above may be distributed to a computer system connected through a network and thus storing and executing a computer readable code by a distributed manner may be used. In this case, at least one computer among a plurality of distributed computers may execute a part of the above-mentioned functions and transmit the executed results to at least one of the other distributed computers, and the computer receiving the result may also execute a part of the above-mentioned functions and provide the executed results to the other distributed computers.

In particular, a computer readable recording medium recorded with applications, which are programs for executing the reward method according to game play number in the online game in accordance with the exemplary embodiments of the present invention, may be a storage medium (for example a hard disk and the like) included in an application store server or an application providing server such as a web server associated with applications or corresponding services, and the like, or the application providing server itself.

A computer, which may read a recording medium recorded with applications that are programs for executing the reward method according to game play number in the online game in accordance with the exemplary embodiments of the present invention, may include not only a general PC such as a typical desktop and a laptop, but also a mobile terminal such as a smart phone, a tablet PC, a personal digital assistant (PDA), and a mobile communication terminal, and is to be construed as all the computable devices.

When a computer, which may read a recording medium recorded with applications that are programs for executing the reward method according to game play number in the online game in accordance with the exemplary embodiments of the present invention, is a mobile terminal such as a smart phone, a tablet PC, a personal digital assistant (PDA), and a mobile communication terminal, the applications are downloaded from an application providing server to a general PC and thus may also be installed in the mobile terminal through a synchronization program.

Hereinabove, although it has been mentioned that all components configuring the exemplary embodiment of the present invention described hereinabove are combined with each other as one component or are combined and operated with each other as one component, the present invention is not necessarily limited to the above-mentioned exemplary embodiment. That is, all the components may also be selectively combined and operated with each other as one or more components without departing from the scope of the present invention. In addition, although each of all the components may be implemented by one independent hardware unit, some or all of the respective components which are selectively combined with each other may be implemented by a computer program having a program module performing some or all of functions combined with each other in one or plural hardware units. The codes and the code segments configuring the computer program may be easily inferred by a person having ordinary skill in the art to which the present invention pertains. The computer programs are stored in the computer readable media and are read and executed by the computer, and may implement the exemplary embodiment of the present invention. As the storage medium of the computer programs, a magnetic recording medium, an optical recording medium, and the like may be used.

Further, it will be further understood that the terms “comprises” or “have” used in this specification may include the corresponding components unless explicitly described to the contrary, and therefore do not preclude other components but may further include the components. In addition, unless defined otherwise in the detailed description, all the terms including technical and scientific terms have the same meaning as meanings generally understood by those skilled in the art to which the present invention pertains. Generally used terms such as terms defined in a dictionary should be interpreted as having the same meanings as those within a context of the related art, and should not be interpreted as ideally or excessively formal meanings unless clearly defined in the present specification.

The spirit of the present invention has been exemplified. It will be appreciated by those skilled in the art that various modifications and alterations can be made without departing from the essential characteristics of the present invention. Accordingly, the exemplary embodiments disclosed in the present invention do not limit but describe the spirit of the present invention, and the scope of the present invention is not limited by the exemplary embodiments. The scope of the present invention should be interpreted by the following claims, and it should be interpreted that all spirits equivalent to the following claims fall within the scope of the present invention.

1. A reward method according to a game play number in an online game through a game operating server, comprising:
searching user information of a user on game access detection of the user to extract a play number as a number of games that the user has finished during a predetermined period;
accumulating the play number every time the play is finished when the user plays the game through the game operating server;
determining whether the accumulated play number is the same as a predetermined play number; and
providing a predetermined reward to the user when the accumulated play number is the same as the predetermined play number.

2. The reward method of claim 1, wherein
the predetermined play number is an integer multiple of a predetermined unit play number.

3. The reward method of claim 1, wherein,
in the providing,
at least one of the item and the cyber money is provided as the reward according to one of a win number of the user in the game play or a successive win number.

4. The reward method of claim 1, wherein
the determining further includes determining whether the accumulated play number exceeds a predetermined threshold play number.

5. The reward method of claim 4, wherein
the providing further includes stopping the providing of at least one of the item and the cyber money when the accumulated play number exceeds the predetermined threshold play number.

6. The reward method of claim 1, further comprising,
after the determining,
outputting a remaining play number to be played by the user until the predetermined play number when the accumulated play number is smaller the predetermined play number.

7. The reward method of claim 1, wherein,
in the accumulating of the play number,
the user only accumulates the winning play number after the play is finished, and
in the providing of the reward,
the predetermined reward is provided to the user when the accumulated winning play number of the user is the same as the predetermined win number.

8. The reward method of claim 1, wherein,
in the accumulating of the play number,
a successive win number as a play number of successive winning is determined is accumulated when it is determined that the user successively wins after the play is finished, and
in the providing of the reward,
the predetermined reward is provided to the user when the accumulated successive win number is the same as the predetermined successive win number.

9. A server delivering a reward according to a game play number in an online game, comprising:
an accumulation module accumulating a play number as a number of games that a user has finished during a predetermined period when the user accesses a game server to play the game;
a reward information generating module generating reward information including an item and cyber money to be used in the game to be provided to the user according to the accumulated play number of the user; and
a management module providing a predetermined reward to the user from the reward information generating module when the play number accumulated by the accumulation module is the same as the predetermined play number.

10. The server of claim 9, wherein
the management module sets the predetermined play number as an integer multiple of a predetermined unit play number.

11. The server of claim 9, wherein
the management module provides at least one of the item and the cyber money according to one of a win number and a successive win number by the user in the game play.

12. The server of claim 9, wherein
the management module determines whether the accumulated play number exceeds a predetermined threshold play number to stop the providing of at least one among the item and the cyber money when the accumulated play number exceeds the predetermined threshold play number.

13. The server of claim 9, wherein
the management module outputs a remaining play number to be played by the user until the predetermined play number when the accumulated play number information is smaller than the predetermined play number.

14. A computer readable recording medium for recording a program for realizing a reward method according to a play number in an online game through a game operating server, comprising:
searching user information of a user on game access detection of the user to extract a play number as a number of games that the user has finished during a predetermined period;
accumulating the play number every time the play is finished when the user plays the game through the game operating server;
determining whether the accumulated play number is the same as a predetermined play number; and
providing a predetermined reward to the user when the accumulated play number is the same as the predetermined play number.
